(19) United States
(12) Patent Application Publication
(10) Pub. No.: US 2017/0030570 A1
(43) Pub. Date: Feb. 2, 2017

(54) STREET LAMP

(71) Applicants: CHAMP TECH OPTICAL (FOSHAN) CORPORATION, Foshan (CN); FOXCONN TECHNOLOGY CO., LTD., New Taipei (TW)

(72) Inventors: JIN-HAO YANG, Foshan (CN); QIAN XIANG, Foshan (CN)

(21) Appl. No.: 14/861,633

(22) Filed: Sep. 22, 2015

(30) Foreign Application Priority Data
Jul. 30, 2015 (CN) 201510455674.5

(51) Int. Cl. F21V 29/76; F21V 21/116; F21S 8/08

(52) U.S. Cl. CPC F21V 29/763; F21S 8/086; F21V 21/116

(57) ABSTRACT

A street lamp includes a housing, a plurality of light emitting units and a driving device supplying power for the light emitting units. The housing includes a first chamber and a second chamber located at an end of the first chamber. The first chamber and the second chamber are non-communicating. The light emitting units and the driving device are received in the first chamber and the second chamber respectively. A plurality of fins are formed on bottom of the first chamber. A plurality of convection holes are defined on periphery edges of the first chamber. The convection holes locate at an outside of the light emitting units.

### CROSS-REFERENCE TO RELATED APPLICATIONS

This application claims priority to Chinese patent application no. 201510455674.5 filed on Jul. 30, 2015, the contents of which are incorporated by reference herein.

### FIELD

The subject generally matter relates to an illumination device, especially relates to a street lamp.

### BACKGROUND

LEDs have been widely applied in the field of street lighting for its properties of energy-saving, environmental protection and durability. A conventional street lamp includes a lamp-body, light sources housed in the lamp-body and a heat sink supporting the light sources. The heat sink is constituted with fins. The cooling efficiency of the street lamp is affected by the shape, number and arrangement of fins.

### BRIEF DESCRIPTION OF THE DRAWINGS

Implementations of the present technology will now be described, by way of example only, with reference to the attached figures.

FIG. 1 is an assembled, isometric view of a street lamp in accordance with a first exemplary embodiment of the present disclosure.

FIG. 2 is an assembled, isometric view of the street lamp in FIG. 1 shown from another aspect.

FIG. 3 is an exploded, isometric view of the street lamp of FIG. 1.

FIG. 4 is an exploded, isometric view of the street lamp of FIG. 3 from a different angle.

FIG. 5 is an assembled, schematic view of the street lamp with a lid opened.

FIG. 6 is an assembled, isometric view of a street lamp in accordance with a second exemplary embodiment of the present disclosure.

FIG. 7 is an assembled, isometric view of a street lamp in accordance with a third exemplary embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially rectangular” means that the object resembles a rectangle, but can have one or more deviations from a true rectangle. The term “comprising” when utilized, means “including, but not necessarily limited to”; it specifically indicates open-ended inclusion or membership in the so-described combination, group, series and the like.

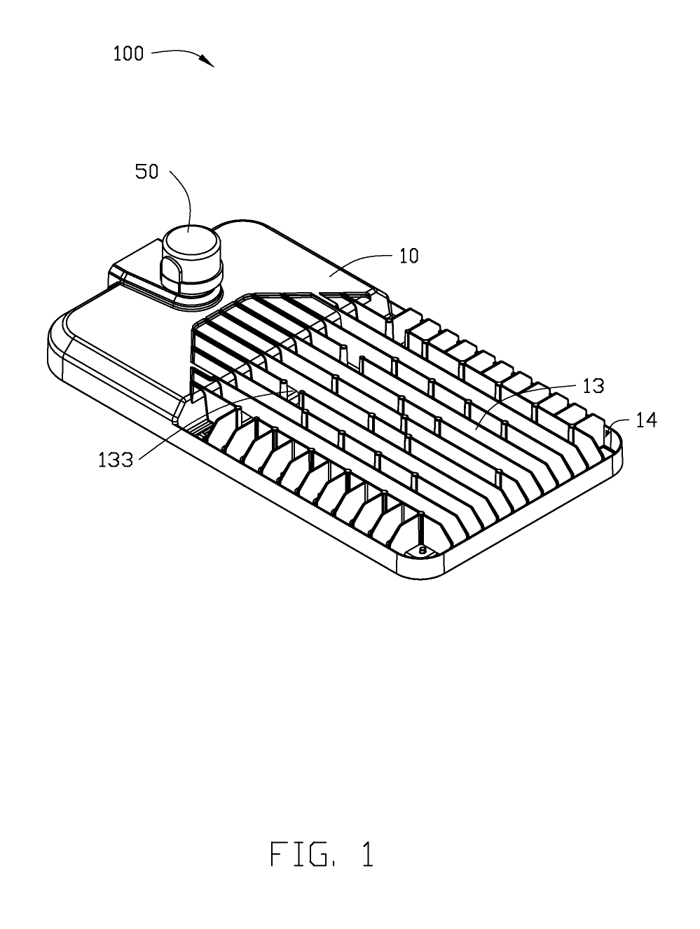

A street lamp 100 of a first exemplary embodiment in the present disclosure is shown in FIGS. 1-5. Referring from FIG. 1 to FIG. 5, the street lamp 100 of the first exemplary embodiment includes a housing 10, a lid 20 connected on the housing 10, several light emitting units 30 and a driving device 40 received in the housing 10.

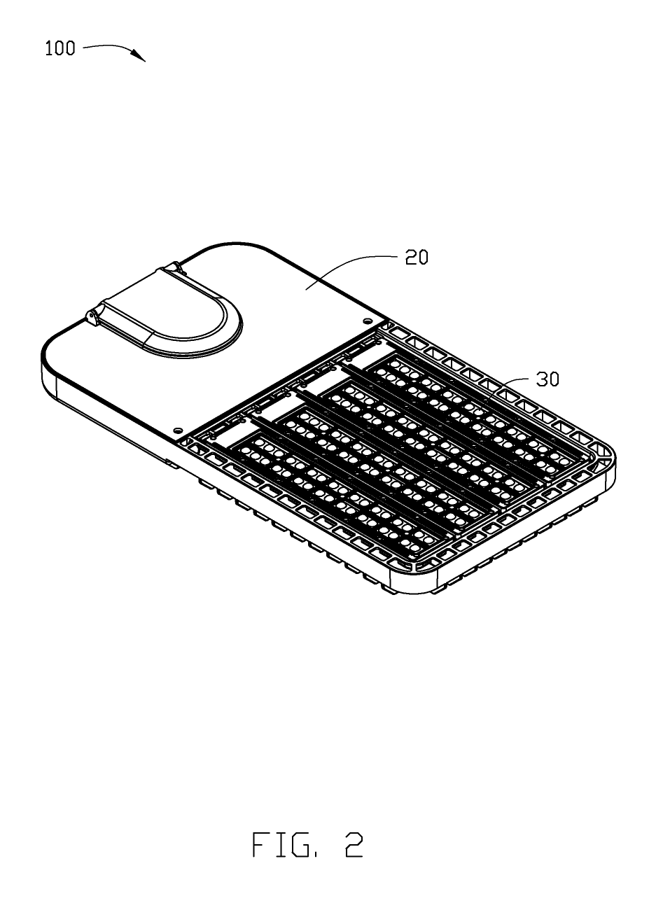

Referring from FIG. 2 to FIG. 4, the housing 10 is integrally made of aluminum alloy via die casting. Thus the street lamp 100 is lightweight and easy to assemble. The housing 10 includes a first chamber 11 and a second chamber 12 located at an end of the first chamber 11. The first chamber 11 and the second chamber 12 respectively receive the light emitting units 30 and the driving device 40 therein. The first chamber 11 and the second chamber 12 are non-communicating. One end of each of the first chamber 11 and the second chamber 12 is closed.

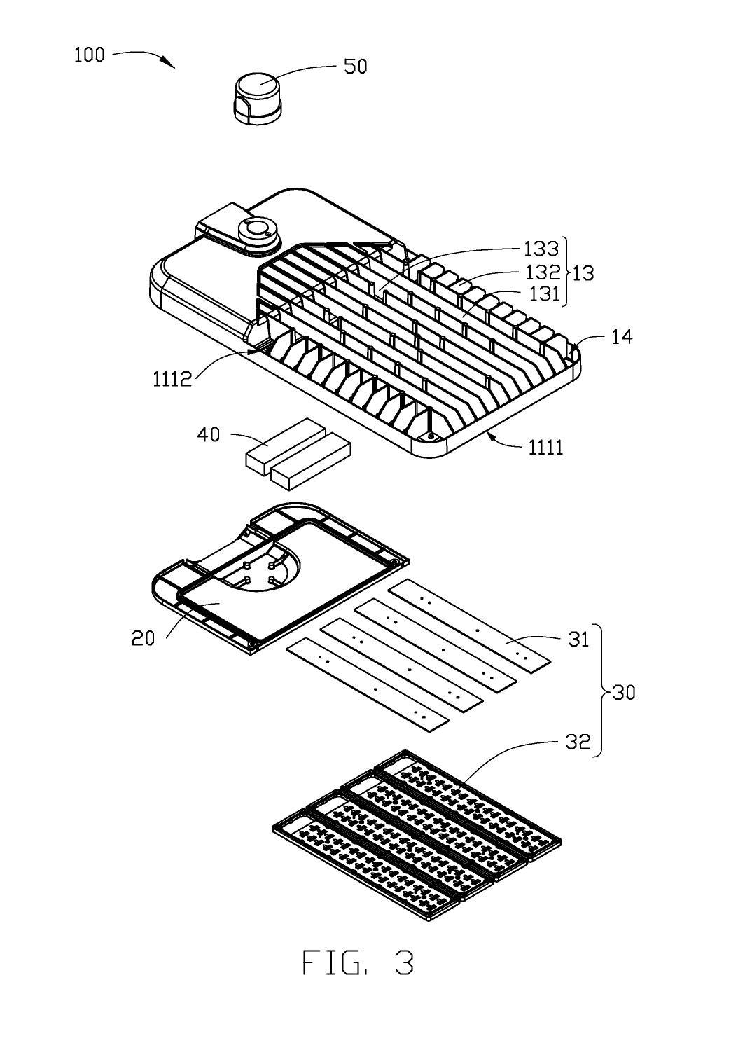

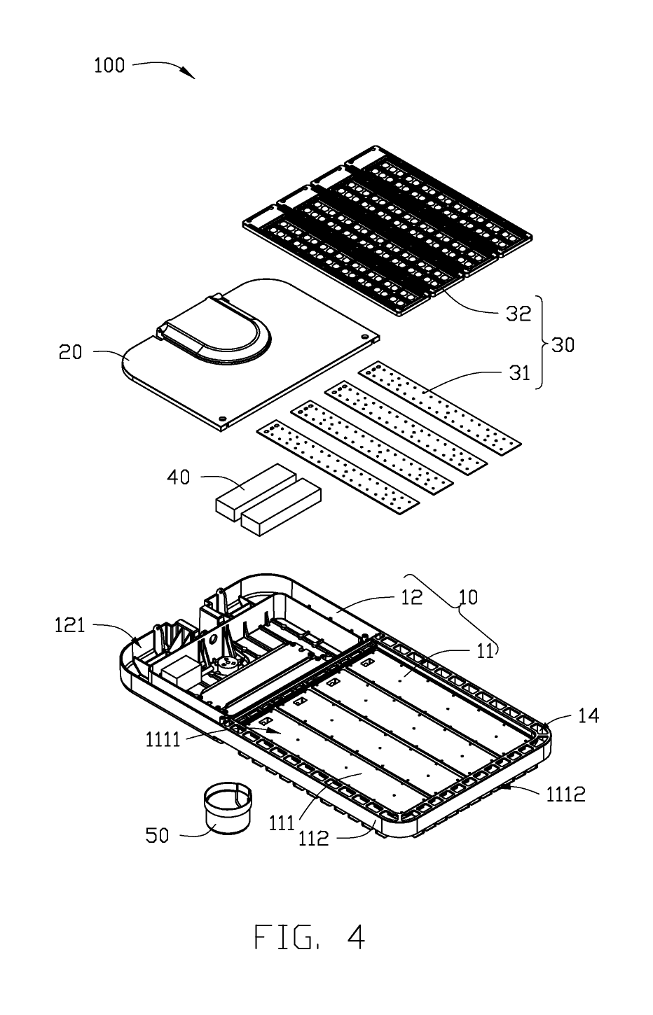

Referring to FIG. 3 and FIG. 4, the first chamber 11 includes a plate 111 and a side wall 112 extending from periphery of the plate 111. The plate 111 is flat for fixing the light emitting units 30. In this exemplary embodiment, the plate 111 is substantially rectangular. The plate 111 includes a front surface 1111 and a rear surface 1112 opposite to the front surface 1111. The front surface 1111 faces the irradiated area and the rear surface 1112 is back to the irradiated area. The side wall 112 extends upwards from periphery of the plate 111 away the rear surface 1112. The plate 111 and the side wall 112 together define the first chamber 11. The front surface 1111 faces the first chamber 11. A plurality of fins 13 are formed on the rear surface 1112 of the plate 111 for dissipating heat.

Referring FIG. 2 and FIG. 4, the light emitting units 30 are fixed on the front surface 1111 of the plate 111. In this exemplary embodiment, the street lamp 100 includes four identical light emitting units 30. Each light emitting unit 30 is a long bar. The four light emitting units 30 are arranged on the front surface 1111 of the plate 111 along a width direction of the housing 10 laterally. Each light emitting unit 30 is fixed along a length direction the housing 10 longitudinally. Thus the light emitting units 30 are parallel to the length direction of the housing 10. Each light emitting unit 30 includes a light source module 31 and a lens module 32. The lens module 32 is configured to cover the light source module 31, thereof improving the optical properties of the light source module 31.

Referring to FIG. 3, the fins 13 are formed on the rear surface 1112. Preferably, the fins 13 locate on an area at least corresponding to the position the light emitting units 30 fixed. In this exemplary embodiment, the fins 13 are spaced from each other and distributed on the whole bottom of the first chamber 11. The fins 13 include first fins 131 and second fins 132. The second fins 132 are perpendicular to the first fins 131.

In this exemplary embodiment, the first fins 131 are formed on center of the rear surface 112 of the plate 111. The first fins 131 are arranged along the width direction of the housing 10 laterally. Each first fin 131 is formed along a length direction of the housing 10 longitudinally. Each first fin 131 is configured in length to line up with the bottom of the first chamber 11. Two adjacent first fins 131 are spaced apart from each other. Several gaps 133 can be randomly defined on the first fins 131.

The second fins 132 are formed beside two sides of the first fins 131. The second fins 132 are arranged along the length direction of the housing 10 longitudinally. Each second fin 132 is formed along a width direction of the housing 10 laterally. Each second fin 131 is configured in width to line up with the bottom of the first chamber 11. Two adjacent second fins 132 are spaced apart from each other.

Referring to FIG. 3 and FIG. 4, a plurality of convection holes 14 are defined on periphery edges of the first chamber 11. Preferably, the convection holes 14 are defined on the side wall 112 of the first chamber 11. The convection holes 14 are spaced apart from each other. In this exemplary embodiment, the convection holes 14 define a rectangular ring. The convection holes 14 are located at an outside of the light emitting units 30 and the first fins 131. Each convection hole 14 is throughout the top and bottom of the side wall 112. Each convection hole 14 is defined between two adjacent fins 13. Preferably, sizes of the convection holes 14 located between the plate 111 and the second receiving chamber 12 is smaller than sizes of the other convection holes 14, thereof enhancing the strength of housing 10.

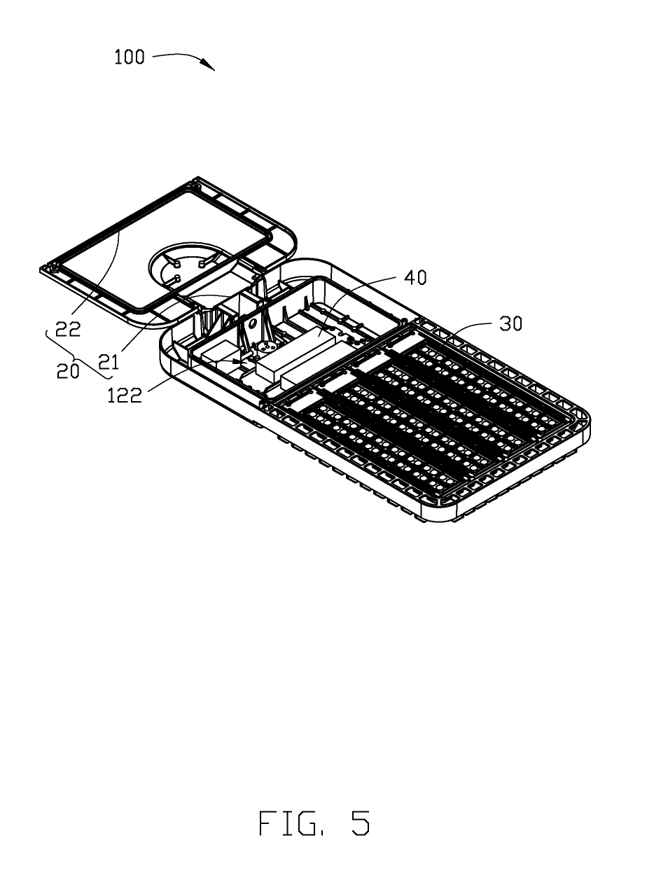

Referring to FIG. 4 and FIG. 5, the second receiving chamber 12 is substantially rectangular. Preferably, a depth of the second chamber 12 is equal to a sum of the height of the fins 13 and a depth of the first chamber 11, thereof improving the overall aesthetics of the housing 10. An opening 121 is formed on the second receiving chamber 12. The opening 121 and the front surface 1111 of the plate 111 face the same direction. In other words, the opening 121 faces the irradiated area. In this exemplary embodiment, the opening 121 is substantially rectangular.

The lid 20 is made of aluminum alloy. A shape of the lid 20 corresponds to a shape of the opening 121 of the second receiving chamber 12. The lid 20 is connected to the opening 121 rotationally. The lid 20 is coupled with the second receiving chamber 12 to form a sealed capacity space 122. The capacity space 122 is used for receiving the driving device 40. The driving device 40 supplies power for the light emitting units 30.

Preferably, the lid 20 includes a pivot end 21 and a free end 22. The pivot end 21 and the free end 22 are two opposite ends of the lid 20 respectively. The pivot end 21 is rotationally connected to one side of the opening 121 of the second receiving chamber 12. Preferably, the pivot end 21 is connected to the side of the opening 121 away from the light emitting units 30. The free end 22 is detachably connected to the other side of the opening 121 of the second receiving chamber 12. Preferably, the other side of the opening 121 is close to the light emitting units 30. The free end 22 can be connected to the opening 121 of the second receiving chamber 12 via clips or screws.

Compared to the traditional street lamps, the fins 13 of the street lamp 100 in the present disclosure are arranged to be corresponding to the light emitting units 30. Thus, heat generated by the light emitting units 30 can be quickly and effectively passed to the fins 13 for cooling. Additionally, a plurality of convection holes 14 are defined on the periphery of the plate 111 and between adjacent fins 13, thereof enhancing heat convection of the fins 13 and obtaining better cooling effect.

Preferably, the street lamp 100 of the exemplary embodiment in the present disclosure further includes a photoreceptor 50. The photoreceptor 50 is used for controlling the street lamp 100 on or off. The photoreceptor 50 is fixed on a rear surface of the housing 10. Preferably, the photoreceptor 50 is fixed on a rear surface of the second receiving chamber 12.

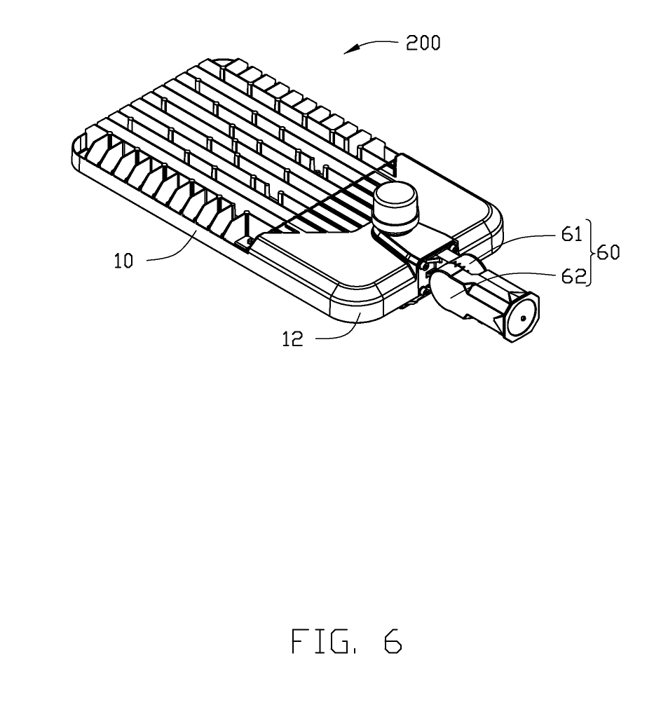

A street lamp 200 of a second exemplary embodiment in the present disclosure is shown in FIG. 6. Referring to FIG. 6, the street lamp 200 of the second exemplary embodiment is different from the street lamp 100 of the first exemplary embodiment.

The street lamp 200 further includes a connector 60 for connecting the street lamp 200 to a pole (not show in FIGs). One end of the connector 60 is rotationally connected to a free end of the housing 10 and the other end of the connector 60 is connected to the pole, thereof adjusting illumination angle of the street lamp 200 freely. In this exemplary embodiment, the connector 60 includes a first connecting part 61 and a second connecting part 62. The first connecting part 61 is fixed on the free end of the second receiving chamber 12 of the housing 10 and the second connecting part 62 is fixed on the pole. The first connecting part 61 is rotationally connected to the second connecting part 62 to adjust illumination angle of the light emitting units 30.

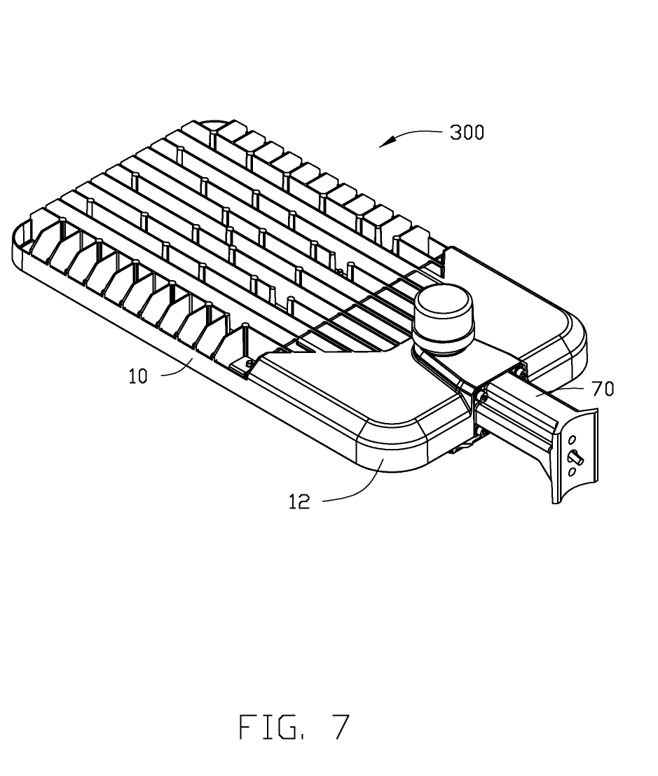

A street lamp 300 of a third exemplary embodiment in the present disclosure is shown in FIG. 7. Referring to FIG. 7, the connector 70 of the street lamp 300 in the third exemplary embodiment is different from the connector 60 of the street lamp 100 in the second exemplary embodiment.

One end of the connector 70 is fixed on the free end of the housing 10 and the other end of the connector 70 is fixed on the pole. Preferably, one end of the connector 70 is fixed on the free end surface of the second receiving chamber 12 of the housing 10. The end surface of the connector 70 fixed on the pole is a curved surface with a large curvature. Thus, poles with circular or square tubule can all be installed.

The embodiment shown and described above is only an example. Many details are often found in the art such as the other features of the street lamp. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A street lamp, comprising:
a housing comprising a first chamber and a second chamber located at an end of the first chamber, the first chamber and the second chamber being non-communicating; and
a plurality of light emitting units received in the first chamber; and
a driving device received in the second chamber for supplying power for the light emitting units;
wherein a plurality of fins are formed on bottom of the first chamber, and a plurality of convection holes are defined on periphery edges of the first chamber, and wherein the convection holes are located at an outside of the light emitting units.

2. The street lamp of claim 1, wherein the first chamber comprises a plate and a side wall extending from periphery of the plate, the plate comprises a front surface and a rear surface opposite to the front surface, and the side wall extends upwards from periphery of the plate away the rear surface, the plate and the side wall together define the first chamber.

3. The street lamp of claim 2, wherein the fins are formed on the rear surface of the plate, the fins comprise first fins and second fins, and the first fins are perpendicular to the second fins.

4. The street lamp of claim 3, wherein the first fins are formed on center of the rear surface of the plate, the second fins are formed beside two sides of the first fins.

5. The street lamp of claim 4, wherein the first fins are arranged along the width direction of the housing, and each first fin is formed along a length direction of the housing.

6. The street lamp of claim 5, wherein each first fin is configured in length to line up with the bottom of the first chamber.

7. The street lamp of claim 4, wherein the second fins are arranged along the length direction of the housing, and each second fin is formed along a width direction of the housing.

8. The street lamp of claim 4, wherein each second fin is configured in width to line up with the bottom of the first chamber.

9. The street lamp of claim 2, wherein the convection holes are defined on the side wall of the first chamber, and the convection holes are spaced apart from each other and define a ring.

10. The street lamp of claim 9, wherein each convection hole is throughout the top and bottom of the side wall, and each convection hole is defined between two adjacent fins.

11. The street lamp of claim 2, wherein the light emitting units are arranged on the front surface of the plate along a width direction of the housing, and each light emitting unit is fixed along a length direction the housing.

12. The street lamp of claim 1, wherein a depth of the second chamber is equal to a sum of the height of the fins and a depth of the first chamber.

13. The street lamp of claim 1, wherein further comprising a lid, wherein the second chamber comprises an opening, a shape of the lid corresponds to a shape of the opening, the lid is connected to the opening to form a sealed capacity space for receiving the driving device.

14. The street lamp of claim 13, wherein and the lid is connected to the opening of the second receiving chamber rotationally.

15. The street lamp of claim 14, wherein the lid comprises a pivot end and a free end, the pivot end is rotationally connected to one side of the opening of the second receiving chamber, and the free end is detachably connected to the other side of the opening of the second receiving chamber.

16. The street lamp of claim 15, wherein the pivot end is connected to the side of the opening away from the light emitting units, and the free end is connected to the other side of the opening close to the light emitting units.

17. The street lamp of claim 1, further comprising a connector, wherein one end of the connector is rotationally connected to a free end of the housing and the other end of the connector is connected to a pole.

18. The street lamp of claim 17, wherein the connector comprises a first connecting part and a second connecting part, the first connecting part is fixed on the free end of the second receiving chamber, the second connecting part is fixed on the pole, and the first connecting part is rotationally connected to the second connecting part.

19. The street lamp of claim 1, further comprising a connector, wherein one end of the connector is fixed on the free end surface of the second receiving chamber and the other end of the connector is fixed on the pole.

20. The street lamp of claim 19, wherein the end surface of the connector fixed on the pole is a curved surface with a large curvature.
